(19) United States
(12) Patent Application Publication
(10) Pub. No.: US 2005/0065761 A1
(43) Pub. Date: Mar. 24, 2005

(54) [INTEGRATED CIRCUIT AND METHOD FOR SIMULATING AND TRIMMING THEREOF]

(76) Inventors: Cheng-Hsing Chien, Hsinchu County (TW); Yu-Yu Sung, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,164

(22) Filed: Nov. 25, 2003

(30) Foreign Application Priority Data
Sep. 19, 2003 (TW) 92125864

(51) Int. Cl. G06F 17/50

(52) U.S. Cl. 703/14

(57) ABSTRACT

An integrated circuit and method for simulating and trimming the same are provided. The integrated circuit includes a multiplexer, a trimming circuit, a major circuit, and a simulating device. The simulating device simulates the operation of the trimming circuit and sends a simulating signal to temporarily change the electric characteristics. Hence, the electric characteristics of the integrated circuit after trimming can be predicted so that the difference between the predicted and real electric characteristics can be reduced and the yield rate can be effectively improved.

### CROSS REFERENCE TO RELATED APPLICATIONS

This application claims the priority benefit of Taiwan application serial no. 92125864, filed on Sep. 19, 2003.

### BACKGROUND OF INVENTION

1. Field of the Invention

This invention generally relates to an integrated circuit, and more particularly to an integrated circuit and method for simulating and trimming thereof.

2. Description of Related Art

The electric characteristics of an integrated circuit will drift due to the fluctuation of fabrication process. For example, for an expected output voltage of 1.2 V, the practical output voltage may range between 1.25V and 1.15 V. This drifting of the electric characteristic causes uncertainty during the design stage. To prevent the undesired drifting of the electric characteristic, one can trim the electric characteristic in order to obtain the desired result.

There are two common trimming technologies poly fuse and laser cut. For the poly fuse trimming, the major part of the integrated circuit is coupled to a trimming circuit. The trimming circuit uses polysilicon for connections. To adjust the electric characteristic, a large current is applied to burn the polysilicon in order to change the electric characteristic of the integrated circuit. The laser cut trimming is similar to the poly fuse trimming. The difference is that metal is used instead of polysilicon and that the laser is applied to burn the metal rather than the current.

FIG. 1 is a block diagram of a conventional integrated circuit with a trimming circuit. The testing device 110 is coupled to the integrated circuit 120 to test the electric characteristics of the integrated circuit 120. The integrated circuit 120 includes a major circuit 121 and a trimming circuit 122. The major circuit 121 and the trimming circuit 122 are coupled together. FIG. 2 is a flow chart for illustrating the process flow for trimming the electric characteristics of an integrated circuit. When trimming the electric characteristics of the integrated circuit 120, the testing device 110 tests the electric characteristics of the integrated circuit 120 (S101). Then, a trimming parameter is obtained for the integrated circuit 120 (S102). Then a laser or a current is applied to trim the circuit structure of the trimming circuit 122 based on the trimming parameter in order to change the electric characteristics of the integrated circuit 120 (S103). Finally, the testing device tests the electric characteristics of the trimmed integrated circuit 120 (S104).

The drawback of the conventional trimming technique is that the engineers can only rely on their experience to predict the electric characteristics of the trimmed integrated circuit. If the prediction is wrong, the trimmed integrated circuit cannot be used, which causes a lower yield rate and increases the costs.

### SUMMARY OF INVENTION

An object of the present invention is to provide an integrated circuit and methods for simulating and trimming. In accordance to the present invention, the result of the electric characteristics of the trimmed integrated circuit can be simulated so that the electric characteristics of the trimmed integrated circuit can be predicted thereby to reduce the unnecessary costs and time.

The present invention provides an integrated circuit comprising: a major circuit providing a major function; a trimming circuit being trimmed for adjusting and fixing an electric characteristic of the integrated circuit; a simulating device simulating the operation of the trimming circuit and sending out a simulating signal to temporarily change the electric characteristic of the integrated circuit; and a multiplexer having an output terminal, a plurality of input terminals, and a selection terminal, the output terminal being coupled to the major circuit, the plurality of input terminals being coupled to the trimming circuit and the simulating device. The selection terminal of the multiplexer receives a selection signal to select one of the simulating device and the trimming circuit to connect the major circuit.

In the first embodiment of the present invention, when performing a simulation operation, the multiplexer connects the simulating device to the major circuit in response to the selection signal. A testing device then tests the electrical characteristic of the integrated circuit and determines a trimming parameter according to the electrical characteristic. The parameter is then sent to the simulating device and the simulating device sends out the simulating signal based on the electric characteristic of the major circuit. The simulating signal is sent to the major circuit to temporarily change the electric characteristic of the integrated circuit. When performing a trimming operation, the multiplexer connects the trimming circuit to the major circuit in response to the selection signal. When performing the trimming operation, the trimming circuit is trimmed based on the electric characteristic of the integrated circuit. The electric characteristic of the integrated circuit is fixed after the trimming operation.

Another aspect of the present invention provides an integrated circuit, the integrated circuit being simulated and trimmed in a testing system, the testing system including a testing device and a simulating device, the integrated circuit comprising: a major circuit, coupled to the test device, providing a major function; a trimming circuit being trimmed for adjusting and fixing an electric characteristic of the integrated circuit; and a multiplexer having an output terminal, a plurality of input terminals, and a selection terminal, the output terminal being coupled to the major circuit, the plurality of input terminals being coupled to the trimming circuit and the simulating device.

In the second embodiment of the present invention, the selection terminal of the multiplexer receives a selection signal to select one of the simulating device and the trimming circuit to connect the major circuit. When performing a simulating operation, the multiplexer connects the simulating device to the major circuit in response to the selection signal. When performing the simulating operation, the testing device detects the electric characteristic of the integrated circuit and obtains a trimming parameter. The simulating device sends a simulating signal to the major circuit based on the trimming parameter to temporarily change the electric characteristic of the integrated circuit. When performing a trimming operation, the multiplexer connects the trimming circuit to the major circuit in response to the selection signal in order to trim the trimming circuit and to change and fix the electric characteristic of the integrated circuit.

The present invention provides a method for simulating and trimming an integrated circuit, comprising: detecting an electric characteristic of the integrated circuit; obtaining a trimming parameter based on the electric characteristic of the integrated circuit; simulating a trimming operation to adjust the electric characteristic of the integrated circuit so that the electric characteristic of the integrated circuit is within an allowable range; and trimming the integrated circuit based on the rimming parameter.

In a preferred embodiment of the present invention, the integrated circuit includes a multiplexer, a trimming circuit, and a major circuit, the step of simulating a trimming operation comprising: the multiplexer connecting the major circuit and a simulating device; the simulating device sending out a simulating signal based on the trimming parameter; detecting the electric characteristic of the integrated circuit; determining whether the electric characteristic of the integrated circuit meets a requirement; and adjusting the trimming parameter based on the electric characteristic of the integrated circuit if the electric characteristic of the integrated circuit does not meet the requirement, and going back to the step of sending out a simulating signal by the simulating device based on the trimming parameter.

The present invention uses a multiplexer in the conventional integrated circuit so that the major circuit can be switch-connected. The present invention also uses a simulating device to simulate the conventional trimming circuit and to send out a simulating signal to temporarily change the electric characteristics of the integrated circuit. Hence, the electric characteristics of the trimmed integrated circuit can be predicted to see if the electric characteristics can meet the requirement, thereby reducing any unnecessary costs and time.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of a conventional trimming integrated circuit.

FIG. 2 is a flow chart illustrating the flow of a conventional trimming process on the electric characteristics of an integrated circuit.

FIG. 3 is the block diagram of an integrated circuit with simulating and trimming functions in accordance with the first embodiment of the present invention.

FIG. 4 is the block diagram of an integrated circuit with simulating and trimming functions in accordance with the second embodiment of the present invention.

FIG. 5 is the flow chart for simulating and trimming the electric characteristics of the integrated circuit in accordance with a preferred embodiment of the present invention.

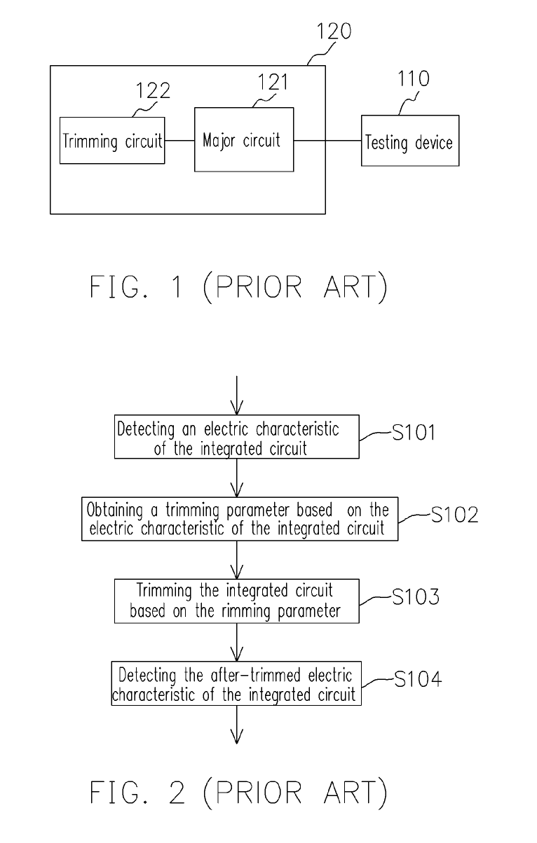

### DETAILED DESCRIPTION

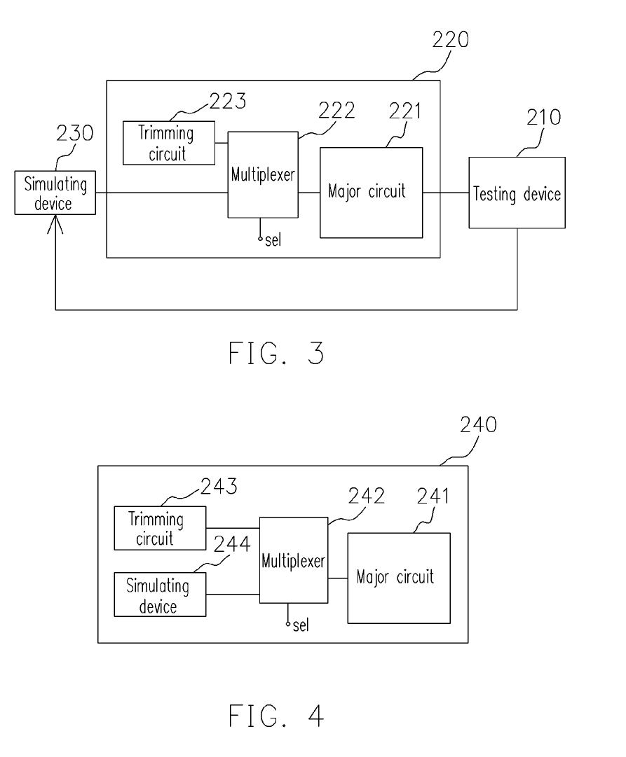

FIG. 3 is the block diagram of an integrated circuit with simulating and trimming functions in accordance with the first embodiment of the present invention. The present invention provides an integrated circuit 220, wherein trimming can be simulated in the testing system, The testing system includes a testing device 210 and a simulating device 230. The testing device is coupled to said integrated circuit 220 and the simulating device 230.

The integrated circuit 220 includes a multiplexer 222, a trimming circuit 223, and a major circuit 221. The multiplexer 222 has an output terminal, a plurality of input terminals, and a selection terminal. The output terminal is coupled to the major circuit 221; the plurality of input terminals is coupled to the trimming circuit 223 and the simulating device 230. The selection terminal sel of the multiplexer receives a selection signal to select one of the simulating device and the trimming circuit to connect the major circuit. The trimming circuit 223 includes a trimmable circuit for adjusting and fixing the electric characteristic of the integrated circuit 220. The simulating device 230 simulates the operation of the trimming circuit 223 and sends out a simulating signal to temporarily change the electric characteristic of the integrated circuit 220.

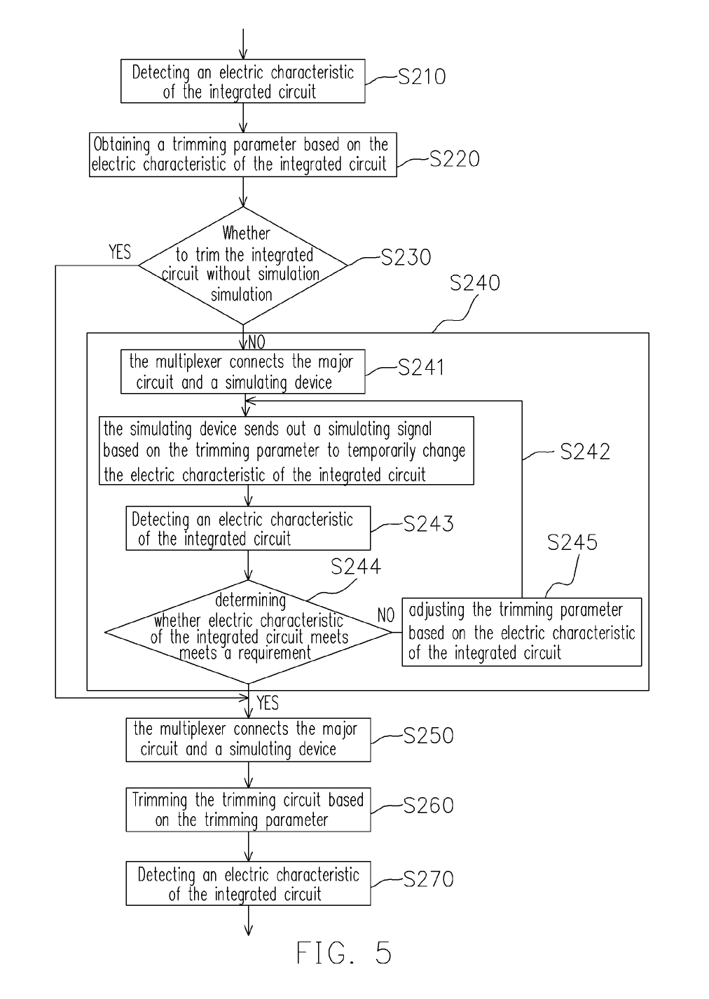

FIG. 5 is the flow chart for simulating and trimming the electric characteristics of the integrated circuit in accordance with a preferred embodiment of the present invention. When the testing device 210 detects the electric characteristic of the integrated circuit 220 (S210), a trimming parameter is obtained based on the electric characteristic of the integrated circuit by looking up a table (S220). For example, if the desired output voltage is 1.2V but the detected output voltage is 1.25V, the look-up table will provide a trimming parameter. When performing a simulation, the steps shown in S240 of FIG. 5 will be performed. When perform a trimming operation without a simulation, the multiplexer 222 will connect the major circuit 221 and the trimming circuit 223 (S250). Then a laser or current will be applied to trim the trimming circuit 223 based on the trimming parameter (S260). Finally, the electric characteristic of the integrated circuit after trimming will be detected (S270), which is a fixed value.

When performing a simulation, the multiplexer 222 connects the major circuit 221 and the simulating device 230 (S241), and the simulating device 230 sends out a simulating signal based on the trimming parameter to temporarily change the electric characteristic of the integrated circuit 220 (S242). The electric characteristic of the integrated circuit is then detected again (S243), and whether the electric characteristic of the integrated circuit meets a requirement (S244) is determined. If the electric characteristic of the integrated circuit does not meet the requirement, the trimming parameter will be adjusted based on the electric characteristic of the integrated circuit (S245) and the flow resumes to step S242.

FIG. 4 is the block diagram of an integrated circuit with simulating and trimming functions in accordance with the second embodiment of the present invention.

The integrated circuit 240 includes a multiplexer 242, a trimming circuit 243, and a major circuit 241, and a simulating device 244. The multiplexer 242 includes an output terminal, a plurality of input terminals, and a selection terminal. The output terminal is coupled to the major circuit 241, while the plurality of input terminals is coupled to the trimming circuit 243 and the simulating device 244. The selection terminal sel of the multiplexer receives a selection signal to select one of the simulating device 244 and the trimming circuit 243 to connect the major circuit 241. The trimming circuit 243 includes a circuit that can be trimmed for adjusting and fixing the electric characteristic of the integrated circuit 240. The simulating device 244 simulates the operation of the trimming circuit 243 and sends out a simulating signal to temporarily change the electric characteristic of the integrated circuit 240. The second embodiment is performed in a same way as the first embodiment, and hence will not be further described here.

In light of above two embodiments, the simulating device can simulate the operation of the trimming circuit and send a simulating signal to temporarily change the electric characteristics. Hence, the electric characteristics of the integrated circuit after trimming can be predicted so that the difference between the predicted and real electric characteristics can be reduced and the yield rate can be effectively improved.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. An integrated circuit comprising:
a major circuit providing a major function;
a trimming circuit being trimmable for adjusting and fixing an electric characteristic of said integrated circuit;
a simulating device simulating an operation of said trimming circuit and sending out a simulating signal to temporarily change said electric characteristic of said integrated circuit; and
a multiplexer having an output terminal, a plurality of input terminals, and a selection terminal, said output terminal being coupled to said major circuit, said plurality of input terminals being coupled to said trimming circuit and said simulating device.

2. The circuit of claim 1, wherein said selection terminal of said multiplexer receives a selection signal to select one of said simulating device and said trimming circuit to connect said major circuit.

3. The circuit of claim 2, wherein when performing a simulating operation, said multiplexer connects said simulating device to said major circuit in response to said selection signal, and said simulating device sends out said simulating signal based on said electric characteristic of said integrated circuit.

4. The circuit of claim 3, wherein said simulating signal is sent to said major circuit to temporarily change said electric characteristic of said integrated circuit.

5. The circuit of claim 2, wherein when performing a trimming operation, said multiplexer connects said trimming circuit to said major circuit in response to said selection signal.

6. The circuit of claim 5, wherein when performing said trimming operation, said trimming circuit is trimmed based on said electric characteristic of said integrated circuit, said electric characteristic of said integrated circuit being fixed after said trimming operation.

7. An integrated circuit, said integrated circuit being simulated and trimmed in a testing system, said testing system including a testing device and a simulating device, said integrated circuit comprising:
a major circuit, coupled to said test device, providing a major function;
a trimming circuit being trimmed for adjusting and fixing an electric characteristic of said integrated circuit; and
a multiplexer having an output terminal, a plurality of input terminals, and a selection terminal, said output terminal being coupled to said major circuit, said plurality of input terminals being coupled to said trimming circuit and said simulating device.

8. The circuit of claim 7, wherein said selection terminal of said multiplexer receives a selection signal to select one of said simulating device and said trimming circuit to connect said major circuit.

9. The circuit of claim 8, wherein when performing a simulating operation, said multiplexer connects said simulating device to said major circuit in response to said selection signal.

10. The circuit of claim 9, wherein when performing said simulating operation, said testing device detects said electric characteristic of said integrated circuit and obtains a trimming parameter.

11. The circuit of claim 10, wherein said simulating device sends a simulating signal to said major circuit based on said trimming parameter to temporarily change said electric characteristic of said integrated circuit.

12. The circuit of claim 8, wherein when performing a trimming operation, said multiplexer connects said trimming circuit to said major circuit in response to said selection signal in order to trim said trimming circuit and to change and fix said electric characteristic of said integrated circuit.

13. A method for simulating and trimming an integrated circuit, comprising:
detecting an electric characteristic of said integrated circuit;
obtaining a trimming parameter based on said electric characteristic of said integrated circuit;
simulating a trimming operation to adjust said electric characteristic of said integrated circuit so that said electric characteristic of said integrated circuit is within an allowable range; and
trimming said integrated circuit based on said trimming parameter.

14. The method of claim 13, wherein said integrated circuit includes a multiplexer, a trimming circuit, and a major circuit, said step of simulating a trimming operation comprising:
said multiplexer connecting said major circuit and a simulating device;
said simulating device sending out a simulating signal based on said trimming parameter;
detecting said electric characteristic of said integrated circuit;
determining whether said electric characteristic of said integrated circuit meets a requirement; and
adjusting said trimming parameter based on said electric characteristic of said integrated circuit if said electric characteristic of said integrated circuit does not meet said requirement, and going back to said step of said simulating device sending out a simulating signal based on said trimming parameter.

15. The method of claim 13 further comprising trimming said integrated circuit based on said rimming parameter without performing said step of simulating said trimming operation if said step of simulating said trimming operation is not desired.
